(19) United States
(12) Patent Application Publication
(10) Pub. No.: US 2008/0095968 A1
(43) Pub. Date: Apr. 24, 2008

(54) Method for producing a micro or nano mechanical part comprising a femtolaser-assisted ablation step

(75) Inventor: Guy Semon, Evette-Salbert (FR)

Correspondence Address: PEARNE & GORDON LLP, 1801 EAST 9TH STREET, SUITE 1200, CLEVELAND, OH, 44114-3108, US

(73) Assignee: TAG Heuer SA, Marin (CH)

(21) Appl. No.: 11/636,024

(22) Filed: Dec. 8, 2006

Related U.S. Application Data
(63) Continuation of application No. PCT/EP05/52652, filed on Jun. 8, 2005.

(30) Foreign Application Priority Data
Jun. 8, 2004 (CH) 2004CH-00970
Jul. 6, 2004 (FR) 2004FR-07485

(51) Int. Cl. B32B 3/26; B23K 26/38; G04B 99/00; B32B 15/00

(52) U.S. Cl. 428/66.1; 219/121.61; 219/121.72; 219/74; 264/400; 368/327; 428/220

(57) ABSTRACT

Method for producing a micro- or nano-mechanical part, for example a pulley or belt for clock/watch making, comprising a laser ablation step which is performed with the aid of a femtolaser, i.e. a laser having a pulse with a duration of less than 5×10⁻¹³ seconds and a power greater than 10¹² watts on the beam/material interaction surface. The part to be machined is pre-modeled in three dimensions and said three-dimensional model is used to generate the machining program.

### RELATED APPLICATIONS

The present application is a continuation of international application PCT/EP2005-052652 (WO05123324), the content of which is included by reference, and which claims priority of Swiss patent application 2004-CH-00970, the content of which is included by reference, and of French patent application FR2004/07485, the content of which is included by reference.

### TECHNICAL FIELD

The present invention concerns a method for producing micro mechanical and nano mechanical parts.

The present invention also concerns parts produced according to this method and intended for use in the field of clock/watch making or outside of this field, for example in the field of measuring instruments, optics, optoelectronics or in other fields requiring a high machining precision, with the exclusion of the ablation of biologic materials.

The present invention also concerns methods for producing transmission elements, such as belts, pulleys, gearings, etc., notably for clock/watch making uses.

### STATE OF THE ART

International application WO04006026 describes a clock/watch movement using pulleys and belts by way of transmission. Watch movements provided with gearings or other types of synchronous or asynchronous transmission are widely known. There is however a constant need for miniaturizing the components of such movements.

The production of these different transmissions is subjected to strict constraints by reasons of the dimensions and of the materials one wishes to use. The requirements as far as the geometry and accuracy are concerned are stringent. Thus, the production of flexible mechanical transmission elements, for example of belts, or of mechanical elements, flexible or rigid, that are often of small size and made of nonmetallic, polymeric, organic or composite materials, causes considerable difficulties. The element's dimensions are often less than 2 mm and the tooth pitch less than 2 mm, even on the order of the hundredth of millimeter.

The one skilled in the art is faced with the following problems:
difficulties in machining and in controlling the machining process,
poorly controllable behavior of the materials (physico-chemical properties),
inappropriate modeling and then reproducing of complex, especially warped, surfaces,
difficulties when using stratified or composite materials,
difficulty for introducing the definition of the functional shapes, for example of the toothing,
lack of traction reinforcements or of low friction coefficient sheathing in the case of belts.

There is thus a need in the prior art for new methods for producing micro and nano mechanical components that allows a machining on a dimensional scale (resolution) varying from the millimeter (10⁻³ meter) to the nanometer (10⁻⁹ meter). Advantageously, this method should be adapted to all materials without distinction, or in any case to wide classes of materials. The machining should be based on a geometric description of the micro or nano mechanical components to be machined, for example of the transmission elements.

There is also a need for new parts or elements, for example for new pulleys and belts, with reduced dimensions and unequalled manufacturing tolerances, that cannot be produced with the conventional manufacturing methods and that could thus not have been conceived of previously.

Methods for machining parts with power laser are known in the prior art. Thus, the use of YAG or CO2 laser diodes that are continuous or with “long” pulses (over 500 femtoseconds) is relatively standard for machining materials such as metals, or the excimer for polymers. These methods are limited when working with small dimensions or on materials that cannot withstand the shocks or heat constraints. It has in fact been observed that the heat transmission in the matter during the pulses, or even continuously, limits the accuracy of the ablation zone. Furthermore, the ablation zone of ordinary lasers corresponds to the cylinder shape of the beam, which limits the shapes that can be machined. The machining depth depends on the beam's power and on the material's properties; this is difficult to control.

### AIMS OF THE INVENTION

The inventive method is based on the machining of elements of small dimensions by ablation of matter by means of ultra-short pulse lasers. In particular, the invention in based on the ablation by means of laser pulses having a duration of less than five hundred femtoseconds (5×10⁻¹³ seconds) and a power greater than 10¹² watts on the beam/material interaction surface. Such pulses are generated by particular lasers called hereafter femtolasers.

Femtolasers as such are known and their technology is currently well mastered, so that these apparatus are compact, polyvalent and reliable. The diversity of these lasers continually increases: the beams achieved today cover the entire electromagnetic spectrum from X rays to T rays (terahertz radiation, beyond infrared), and the maximum power reaches several petawatts (several billions of megawatts). These devices are used notably in physics, chemistry, biology, medicine, optics.

Owing to the extremely short duration of their pulses, they make possible the study of the ultra-fast phenomena occurring at microscopic or atomic level. Furthermore, very high powers can be produced during the short duration of the pulse, creating extreme conditions, often comparable to those encountered in fusion reactors.

Use of the ultra-short pulse laser for machining micro mechanical elements offers the following advantages:
machining precision,
ablation of matter in practically athermal (thermoneutral) conditions,
there is an effect only at the “beam waist” focal point, the beam can, especially in the case of transparent materials, go through thicknesses in order to work at a point in the mass without alteration to the surface or to the matter on the traveled path,
the beam is manipulated at a distance and under all angles,
there are no restrictions as regards the machined materials,
it is possible to achieve a resolution finer than the width of the laser beam by adjusting the laser so that only the intensity of the central part, where the greatest power is concentrated, is greater than the material's ablation threshold (controlling the energy density in the focal plane),
no machining efforts as far as the ablation aspect is concerned.

Use of femtolasers for matter ablation is known as such and described in the articles “Kautek et al., “Femtosecond pulse laser ablation of metallic, semi-conducting, ceramic, and biological materials”, SPIE vol. 2207, pp. 600-511, April 1994” and “Liu, X. et al., “Laser Ablation and Micromachining with Ultrashort Laser Pulses”, October 1997, IEEE Journal of Quantum Electronics, vol. 33, N^{o} 10, pp. 1706-1716”.

U.S. Pat. RE37585 describes a method for destroying a matter with the aid of a pulsed laser beam, characterized by a fluence rupture threshold (Fₜₕ) to width of laser beam (T) ratio that shows an abrupt, rapid and clean inflection, or at least a clearly detectable and clean inflection, of the gradient for a predetermined value of the width of the laser beam.

The method of the present invention is notably advantageous thanks to the use of pulses of a particularly short duration and of particularly high powers. These extreme conditions allow the accurate machining of highly varied materials with the same equipment. The power or duration of the pulses can however be adapted to the material or to the speed and precision required for machining a portion of a part.

The invention is thus also based notably on the observation that use of extremely high powers, clearly greater than the powers used in conventional laser machining methods, allows a nearly instantaneous, explosive sublimation of the zone irradiated by the laser beam. Despite the small size of this zone, the machining is thus relatively quick. Furthermore, by interrupting the light pulse after a very short time, the ablation is limited to the zone directly irradiated, without touching the neighboring portions. The considerable powers used thus allow an extremely clean cutting, with sharp edges, of the parts to be machined.

The invention is also based on the observation that the femtolaser is adapted for machining new types of parts and new materials, in particular parts of small dimensions and high precision, notably of horological elements for which the femtolaser had not been previously suggested. The invention also concerns such elements produced with the femtolaser and thus having dimensions, precisions and surface states previously considered nearly unachievable.

The inventive method thus makes it possible to machine parts having a dimension equal to or less than 2 millimeters or preferably less than one millimeter, this dimension being counted overall and defined as the length of the segment that connects the two most distant points of an element part along the same direction. The method also makes it possible to machine parts having teeth whose depth is less than two millimeters or even less than 0.5 millimeters.

The part is preferably held by a micro-manipulator ensuring the positioning and orientation of the surface to process relatively to the orientation of the laser beam. The part to be machined can be held by a multi-axial system controlled by a micrometric or even nanometric robot machining program with play compensation or retrofit. The movement of the part, small and very light, can generally be performed much faster and with a greater precision and reproducibility than the movement of the laser or of the associated optics. It is however also possible to move the laser or to deviate the beam simultaneously or even uniquely.

The ablation zone can thus be modified by translations of the part to machine at least in one plane (axes X and Y), by rotations in this plane along the axis C, and preferably also by translations along an axis Z perpendicular to the plane and/or by rotations along two perpendicular axes A and B. As indicated, the displacements of the laser or of the associated optics can also be conceived. Furthermore, the focal distance can also be controlled according to a direction parallel to the axis Z.

The displacements are controlled by a machining program that receives data corresponding to a description of the shape to be machined. The description is given in mathematical form and the machining program determines the trajectories the laser beam must travel, continuously or in steps, for generating these shapes. The invention is based on a geometric description making use of new curve families and taking into account the femtolasers' capabilities of producing an ablation only at the focal point, at an accurate distance from the laser. The conditions of the ablation can be optimized according to the material and of the depth of machining, which can be modified for example by defining the incidence angles of the laser beam and the positioning of the element to machine relatively to the laser beam.

Advantageously, the method further includes the steps of:
describing the shapes of the part to machine from the geometry defined with the aid of a CAD with a 2D, 2D and a half or preferably 3D representation,
transferring the data coming from the CAD onto a machining program, preferably three-dimensional, that preferably allows interpolations of warped surfaces to be performed,
defining the pitch according to the material and the machining depth, so that the ablation conditions can be optimized,
entering the data in the movement control and/or steering information processor,
positioning in one direction the focal zone through lighting by means of an optical head, equipped or not with a diffraction device,
positioning the part to machine on the work surface,
holding the part to machine through fastening means,
adjusting the ultra-short pulse laser,
starting the machining program and machining the component by ultra-short pulse laser.

According to an advantageous variant embodiment, the inventive method is realized in controlled atmosphere in order to avoid the occurrence of non-linear phenomena generated on the level of the light/material interface, for example air breakdown or modification of the physico-chemical properties of the environment.

The invention also concerns the parts produced by the method. The invention also results from the observation that femtolaser-assisted ablation machining is suited to producing highly diverse parts, notably parts and elements having extremely reduced dimensions and that must be produced with a very fine resolution, which could not be produced in the prior art or only with considerable difficulty. The invention thus also concerns notably transmission elements, notably small-size elements for horological use for example, made according to this method. The invention also results from the observation that femto-laser machining is perfectly suited for machining pulleys and transmission belts of synthetic or composite material, having very small dimensions adapted to clock/watch making, or of moulds designed for injection or molding of such belts and pulleys.

Advantageously, at least one of the dimensions of the part machined according to the invention is less than two millimeters and advantageously less than 0.5 millimeters. The method is also adapted for machining parts that have at least one irregular or warped surface characterized, among others, by at least one radius situated in the curve plane whose value is greater than 10⁻⁹ m and less than 10⁻³ m, preferably less than 10⁵ m.

### BRIEF DESCRIPTION OF THE DRAWINGS

Examples of embodiments of the invention are indicated in the description illustrated by the attached figures in which:

FIG. 1 represents by way of example a device for producing parts according to the inventive method, adapted for machining synchronous/asynchronous transmissions,

FIG. 2 represents a synchronous/asynchronous transmission constituted here by a so-called parallel-strand pulleys-belts unit,

FIG. 3 represents a curved tooth profile,

FIG. 4 represents two examples of asynchronous transmission with auxiliary pulleys placed inside resp. outside the transmission,

FIG. 5 represents a cross-sectional view of a stratified belt.

### EMBODIMENT(S) OF THE INVENTION

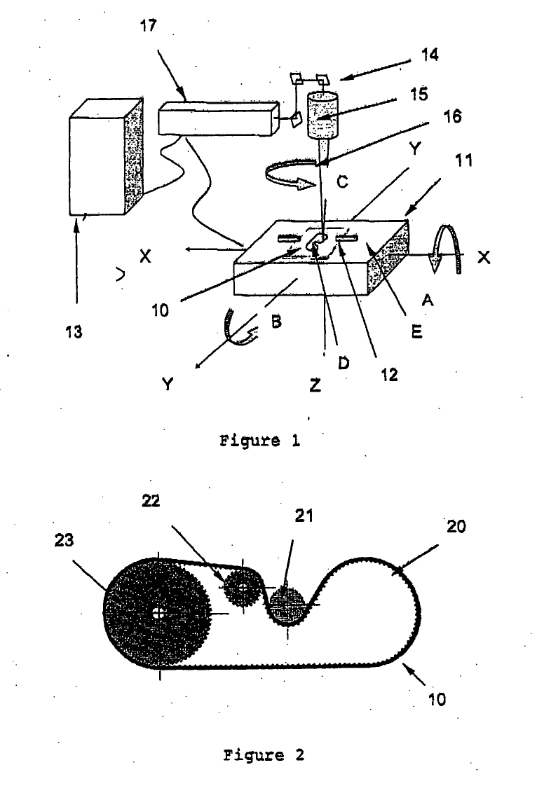

FIG. 1 illustrates a device for producing a part 10, here a synchronous or asynchronous transmission, for transmitting movements or power, and including:
a work surface 11 having in this example 6 programmable axes (A, B, C, X, Y, Z) and holding means 12 (for example systems such as straps, adhesive, magnets, vacuum etc.). The axes are controlled by a micrometric robot machining program executed by the information processor 17, with means for compensating or retrofitting play,
an information processor 13 having notably a three-dimensional modeling software such as for example a 3D CAD system,
a ultra-short pulse laser 14 of the femto type, having an optical head 15 allowing the emitting of a beam 16 concentrated on a focal zone (D),
displacement control/steering information processor 17.

Machining Method

The information processor 13 can be constituted for example by a personal computer or a work station and allows a software to be executed that allows a three-dimensional model of the part to machine to be generated and stored, and then a machining program to be generated from this three-dimensional model.

The machining program includes a series of instructions to move the device's axes so as to displace the femtolaser's focal zone according to a three-dimensional trajectory allowing the part to be machined. Generating the trajectory is based on interpolations and the size of the indexing steps is a function notably of the speed, the precision and the surface state required. The machining program can be determined once and applied to the machining of many identical parts.

The control/steering information processor 17 executes the machining program and can be constituted for example of a numeric control or an industrial PC for controlling the axes' motors or actuators in order to control the translations and rotations of the displacement axes of the laser 14, of the associated optics and/or of the part to be machined, so as to modify the relative position of the irradiated zone D of the part 10 to be machined. The information processor 17 thus addresses orders to a power servo device composed of variators and electric actuators that generate the axes' movements with the required precision and speed.

The combination of rotations and translations according to the six axes (A, B, C, X, Y, Z) in space makes possible the machining of practically any part 10, even a complex one.

A method for producing a part 10, for example a synchronous/asynchronous transmission by micro belt, includes notable the following steps:
describing the shapes to be machined, for example from the geometry defined on a plane of a 3D CAD system with the aid of the information processor 13,
transferring the data onto a three-dimensional machining software taking into account notably the interpolations of the warped surfaces and executed by the information processor 13 or by the information processor 17,
defining the pitch (distance of displacement of the ablation zone between each pulse) according to the material and the machining depth so as to optimize the ablation conditions,
entering the data into the information processor 17 that controls and steers the displacements; the data transfer between the information processors 13 and 17 can occur through a network, for example of the type LAN or internet, or via a magnetic, optical or electronic data support,
positioning, in the direction Z, the focal zone D through lighting by means of an optical head 15, equipped or not with a diffraction device,
positioning and rotating in the plane E (defined by the axes X and Y) the part to machine,
fastening the part to machine 10 through fastening means 12, in order to position and hold the part,
adjusting the ultra-short pulse femtolaser, with pulses whose duration depends on the material, but preferably less than 500 fs (5×10⁻¹³ seconds) and whose intensity depends on the material,
starting the machining program and machining the part 10 by femtolaser; the machining program requires that a series of laser pulses be generated along a continuous or discontinuous trajectory traveled by the irradiation zone, so as to cause the ablation of the irradiated zones; the trajectory of the ablation zone, and thus the shapes to be machined, is described from the geometry defined on a plane of 3D CAD system; a time step is defined according to the material and the machining depth so that the ablation conditions are optimized.

Comparative tests show that the fact of passing from 100 to 10 fs improves considerably the machining precision. The fluences used in micro-machining conventionally vary from 0.2 to 50 J/cm² according to the sought machining quality and speed, preferably less than 10 μm by pulse, and typically at least by 0.5 to 0.25 μm/pulse according to the machined materials. The ablation precision is clearly improved relatively to convention laser of the type picosecond or excimer.

The ultra-short pulse laser does not dissipate heat outside the irradiated volume, irrespective of the machined material. The athermal (thermoneutral) nature of the method is due to the shortness of the pulses in conjunction with a very high intensity on the order of 10¹⁴ Watt/cm² at the level of the beam's focal plane. The current tendency orients the tools towards pulses of 100 fs (1.0×10⁻¹³ seconds) for an energy on the order of the MJ/pulse.

Physically, the electrons undergo a heating due to the phenomenon of the inverse “Bremsstrahlung” (deceleration radiation) type. The ejected electrons transmit their energy to the other electrons of the atom network through shocks and cause an ionizing avalanche that causes matter to be expulsed. The transfer of energy of the electrons to the atom network of the machined material occurs in a lapse of time that is about 1000 times less fast than the duration of a pulse. The ablation of matter thus occurs before any thermal diffusion can take place outside the irradiated zone.

The energy gradient of the laser beam is thus preferably determined so that only the intensity of a central zone whose section is less than 50% of the beam's total section is greater than the material's ablation threshold. The machining resolution is thus lower than the beam's maximum diameter.

In one variant embodiment, two perfectly synchronized and non-parallel femtolaser beams are used. The intensity of each laser is less than the material's ablation threshold, which is machined only at the intersection point of both lasers. It is thus possible to machine hollow parts.

The intensity of the pulses or their duration can preferably be adapted by the control means of the information processor 17, according to the material to be machined and the requirements regarding precision and speed. It is thus possible to modify these parameters during a machining cycle of a same part.

Generally, the relative displacement between the laser beam and the part to be machined is based on the spatial manipulation of the part's support. It will be noted in the inventive method that for particular cases, the beam could be deviated, independently of the displacements of the part to ablate, at the exit of the optical head, by means of different mirror optical systems, scanner, telescope etc. A displacement of the laser is also conceivable, but its inertia risks making its displacements slower to stabilize than those of the part.

Most of the shapes machined on the elements coming into the making of the transmissions 10 or of any other micro or nano component can be machined in one plane. As in the case of the machining of more complex surfaces such as complex toothings (not represented), it is possible to move the impact point of the beam 16 of the laser simultaneously according to three axes, or even four axes with a rotation plane 11 and a pivoting optical head 15.

The part's displacement speed results from a compromise according to the desired production rate, the required precision or resolution and of the sought surface state. Many parts will thus be machined through a series of displacements at variable speed.

In order to prevent non-linear phenomena from appearing as a result of light/material interface, the machining could occur in a vacuum or under projection of neutral gas (helium, argon . . . ). The machining in controlled atmosphere makes it possible to avoid non-linear phenomena generated within the light-material interface, such as for example air breakdown at the level of the focal plane and the corollary appearing of instability altering the machining quality. In the case of specific uses, in order to improve the ablation's energetic efficiency, it will be possible to improve the optical precision by adopting a diffraction system or an optical servo device mounted to complement of the focalization device.

Geometric Representation of the Parts to be Machined; Displacements of the Irradiation Zone

The most current displacements that can be performed by the part's irradiation zone are:
a) quick positioning, which constraints the mobile elements to achieve the programmed point by traveling a linear trajectory at the maximum speed allowed by the machine,
b) linear interpolation that allows the programmed point to be reached by traveling a linear trajectory at the advancing speed specified by the programmer,
c) circular interpolation whose function it is to describe complete circles or arcs of circle from certain characteristic geometric elements that define them, such as the coordinates of the centre and those of the extrema for example,
d) helical interpolation that combines a circular movement in one plane with a translation movement perpendicular to this plane,
e) conical interpolation in the plane, where each parabolic segment is geometrically defined by a group of 3 points, the last point of a segment being the first of the following segment,
f) polynomial interpolation that allows trajectories to be defined from polynomial degrees and which is used for curve-fitting the spline-type curves.

In the case of the production of micro transmissions, for example of belts, most of the shapes can be machined in one plane. To this effect, one resorts to 2D or 2D½ machining techniques. The following machining operations can be performed by means of the inventive method and device:
a) contouring (mode where the tool remains positioned at a constant depth whilst it describes, in the plane, a series of straights and curves),
b) drilling and its connected operations,
c) machining negative volumes.

In the case of the machining of more complex surfaces such as toothings or warped surfaces, the laser's beam will be moved simultaneously along three axes or even more with a rotating plate and an optical head capable of pivoting. A pivoting of the optical head along two axes (twist head), on a pivoting plate, is also possible. Finally, it is also possible to displace the focal distance parallel to the axis Z.

The inventive machining method is notably advantageous due to the fact that the allowed geometries are not limited to segments of straights (simple interpolation) or to circles. Furthermore, it is common, notably in the conventional machining techniques used in clock/watch making, to encounter drafts or connections determined in a more or less vague or even implicit fashion (geometric resulting from the intersection of two surfaces set by the shape of the tools). Obviously, these conventional methods are not suited for machining complex and notably warped shapes and more widely for all operations where an accurate control of the intersections of surfaces (fillets) is required.

In order to allow machining through matter ablation, in all possible cases, the shapes or surfaces to treat can be defined by means of mathematical principles calling upon geometry and algorithmics (graphs, algorithmic geometry, probabilistic algorithms . . . ).

Conventionally, the geometric representation of the complex surfaces generated by the matter ablation method by means of an ultra-short pulse laser requires the definition of special curves called free-form curves. The most current representation method is the one using Bézier curves. One known evolution is also encountered under the name of B-spline curves.

For more complex shapes and notably for those that fall into the definition of curvilinear profiles for which conics are necessary (arcs of circles, ellipses, parabola, etc.), rational curves are used where the representation of the conics is generated by a polynomial quotient and not by an integral polynomial parametric equation. For defining the surfaces to be machined, the most common rational curves can be used, namely the rational Bézier curves defined by polynomials where one surface is decomposed into simple elements called unit cells defined each by points called poles, or spline and NURBS (non-uniform rational b-spline) curves defined by sets of points forming surface tiles in a network.

These families of curves can be explained more accurately:
Bézier curves: parametric curves notably calling upon the following concepts: Bernstein polynomials, De Casteljau evaluation algorithm, subdivision, degree elevation, derivation, geometric properties (affine invariance, convex hull, variation reduction),
B-spline functions: defined as basis of P(k,t,r), knot multiplicity, Cˆk class connection, local and minimal supports,
B-spline curves in the form of parametric B-splines calling upon concepts of control polygons, de Boor evaluation algorithms, and having notably geometric properties such as for example affine invariance, local control, convex hull, multiple knots at the edges, insertion of knots,
Geometric spline curves that answer the notion of geometric continuity, geometric invariants, as well as the known forms Frenet frame, nu-splines, tau-splines.

The machining method by matter ablation by means of an ultra-short pulse laser is distinguished over other machining methods in that it uses indistinctly, depending on the required machining precision or complexity, data algorithms based on the following mathematical principles, without this list being exhaustive:
curvature, torsion, Frenet frames, Jordan theorem, isoperimetric inequalities, focal hulls or curves,
surfaces and hypersurfaces as the two fundamental forms of a surface and notably the curvatures, Gauss-Bonnet formula, intrinsic geometry, parallel transportation, geodesics,
Morse theory for connecting the homotopy type of a variety to the critical points of a generic function having certain good properties, including the demonstration of the Gauss-Bonnet formula but also the Hessian, the critical points and the Morse lemma,

Functions defined on a surface such as height and distance functions,
Vector fields and Morse diagram, notably the techniques used in reconstruction theories,
Combinatory and algebraic topology elements, and notably: triangulation, simplicial complexes, Euler-Poincaré characteristic, varieties, theorem of the classification of surfaces,
Differential geometry elements: surface geometry in R³: Gauss application, principal curvatures and directions, classification of points (elliptical, hyperbolic, parabolic, plane), focal and geodesic surfaces,
Euclidian quadrics and smooth-surface osculating quadrics,
Skeletons under the aspect of plane curves, evolute, skeletonization, as well as their geometric criteria (distance to the skeleton, differentiability of the distance, ridge and ravine functions) and their topological properties (homotopies and retracts),
References to the Voronoï diagram, Delaunay 2D triangulations and skeleton approximations,
Reconstruction and meshing of surfaces taking into account notably the restricted Delaunay triangulation, the nerve theorem of homotopies and homeomorphisms but also sampling criteria of curves and surfaces,
Surface refining algorithms, algorithmic geometry and notably segment intersections, 2D and nD convex hull computation, duality properties, linear programming,
Geometric data structures, complex or not, calling upon deterministic and probabilistic algorithms,
Use of interpolation and smoothing algorithms as well as cross-validation relating to the choice of smoothing parameters and notably, without this list being exhaustive:
   least square smoothing (taking into account weights and constraints),
   interpolation by polynomial splines, spline spaces, minimization of an energy, computation algorithm of the interpolation spline, spline bases (S-spline),
   spline smoothing: smoothing splines, computation algorithms, cross-validation methods for the choice of the smoothing parameter.

The ablation method described in the present invention is based widely on algorithms using the NURBS (Non Uniform Rational Basic Splines) technique.

We define these NURBS as a set of techniques serving for interpolation and approximation of curves and surfaces. These techniques are very present in formal and digital computation systems and taken over by the main geometric modeling software such as for example CAD or CAD/CAM tools.

These functions are defined from real values called knots that correspond to the uniform case. They have a given degree that, for the standard shapes we machine, is 2 or 3 and rarely more. Their value is comprised between 0 and 1 but is not zero only over one interval.

The higher its degree, the smoother the described function:
degree 1=continuous function,
degree 2=derivable function (no angular points),
degree 3=twice derivable function (non curve rupture).

When a knot is modified, the function deforms continuously.

When two knots coincide (the knot becomes double), there is a loss of continuity with either a discontinuity or an angular point or a curve rupture.

The continuity order in one knot equals the degree minus the multiplicity of the knot, for example:
B-spline of degree 2, simple knot->derivability,
B-spline of degree 2, double knot->angular point,
B-spline of degree 2, triple knot->discontinuity.

In the case of curves defined by control points (for example toothing profile), points of the plane (called control points) and a set of values (called knot vector) are given. Fundamental properties can be mentioned:
1) The curve is entirely contained in the convex hull (since the coefficients of the combination are comprised between 0 and 1 with a sum equal to 1).
2) This definition does not depend on size, it can thus be used both in the plane as in three-dimensional space and even beyond.
3) The curve depends only on the relative position of the knots; if a translation or a homothecy is performed, the curve remains unchanged; the knots (0, 0, 1, 2, 4, 4, 4) will give the same curve as (−1, −1, 1, 3, 7, 7, 7).
4) When a basis function is worth 1, the others are zero and the curve passes by the control point that is in particular associated with it, when the first (respectively last) knot is multiplicity, the first (respectively last) basis function is worth 1 and the curve passes by the first (respectively last) point, one has a so-called floating extremity curve, of which the Bézier curves are a special case.

It is interesting to finally determine the role of the homogenous coordinates building relational curves.

It will finally be noted that the mathematical method described previously is the only one that can guarantee homothecy factors useful for the sound practice of the theory of the mechanisms applied to micro and nano mechanisms (respecting the sliding, friction, meshing etc. conditions).

Parts and Components that can be Made with the Inventive Method

Femtolaser-assisted ablation machining is adapted to manufacturing parts and elements that have reduced dimensions and that must be manufactured with a very high resolution, notably but not exclusively in the field of horology. This method is particularly suited when at least one of the part's dimensions, in at least one direction, is lower than or equal to 2 millimeters. The dimensions are counted overall and defined as the measurement of the segment that connects the two points of a same part that are most distant along a same direction. More generally, this method is suited for manufacturing all the micro mechanical and nano mechanical elements whose definition of the contact radius (intersection of two surfaces) requires millimeter-accurate dimensional conditions.

The inventive method is thus for example adapted to the manufacture of transmission elements, notably small-dimension elements for horological applications for example.

The manufactured parts can have at least one curvilinear line, often irregular, formed in a perpendicular plane, at least one radius greater than 10⁻⁹ m and less than 2 mm. One example can be given by observing the edges that mark the intersection of two surfaces produced by any machining. At macroscopic level (on a scale of some millimeters, 10⁻³ m), these edges can be assumed to be rectilinear or circular and formed by protruding or obtuse angles. However, at microscopic level, these same lines are characterized, in the plane perpendicular to the edge line, by a more or less regular geometry having at least one radius, often called fillet, of some tenths of millimeters at most.

The inventive method is notably adapted for machining all or part of the following horological elements:
the body of a watch, and notably the plate having recesses and holes and serving as supporting frame,
the bridges of straight or warped shapes serve for holding or guiding in rotation or in translation the different components of a micro mechanism,
the material connection between solids, and notably encasing, slide, simple or sliding pivot, translation and rotation, helical, plane support, simple or finger ball-and-socket joint, linear annular, linear rectilinear, punctual . . . .
the energy-accumulating elements, in particular the springs, and the barrel components,
the micro or nano transmission devices by straight or warped gears, pulleys, friction wheels, rigid or flexible homocinetic connections, hydrostatic and hydrodynamic elements,
pivoting or sliding connections,
mechanical storage elements, notably cams,
components relating to the escapement function and notably those serving to distribute power, notably systems with detent, cylinder, English lever, pin, recoil wheel etc., notably the following elements: escapement wheel, escapement tooth, rim, arm, hub, lever, stick, pallet, or incoming or outgoing impulse, fork, input or output fork, dart, limiting, input or output pin, big and small safety roller, balance,
the oscillating elements, called regulating elements, be they of the pendulum or spiral-balance family, and, more generally, all the vibrating systems in dampening mode or not, linear or not, having or not mechanical or visco-mechanical dampening devices, including the following adjacent elements: balance cock, balance, collet, stud, stud-bearer, index, balance spring, balance based on complex left or right uncoiling helicoids, the elements connected to turning regulating systems and in particular, without this being in any way limiting, the tourbillons or carrousels,
oscillating masses, be they revolution, linear or pivoting,
striking elements,
external elements, such as notably glass, bezel, middle, winding button, correctors, dial, hands, casing ring, bottom, lugs, wristlets and their components, push buttons, display cell, crowns, display symbols such as simple or perpetual date indicators, time setting indicators, moon phase indicators, dial index,
the casing, be they made of one or several parts, having or not elements such as: winding button, crown, push buttons . . . .
   Manufacturing Belt Transmissions

As indicated, the inventive method is also suited for manufacturing synchronous or asynchronous transmissions, in particular micro and nano transmissions, for example pulleys, smooth or toothed belts, chains, right or left gearings, homocinetic transmission elements, etc. Such transmissions are used for example in the field of horology or in other miniaturized devices. Some examples of transmissions machinable with this method will thus not be described in more detail.

In one embodiment, the movement/power transmissions using belts made with the inventive method are asynchronous and are composed of at least one wheel, one flat or trapezoidal or striated belt, and preferably have at least one tensioning and/or guiding runner located inside or outside the micro belt. The asynchronism comes from the sliding possibility of the belts on the pulleys under the action of too high a torque.

Furthermore, the asynchronous micro belt transmissions can be mounted on pivot or slide bar connectors, which allows the winding angle on the pulleys to be increased or coupling/uncoupling functions to be ensured.

The synchronous belt micro transmissions are composed of at least two toothed wheels and of a toothed belt of the same module, which has the effect of allowing the mechanical power to be transmitted between a motor element and a receptor element without sliding, thus correcting the problem caused by the functional or accidental sliding of the asynchronous transmissions, notably in the case of overload. The micro or nano mechanical chain will be considered here as being a particular form of the notched belt since it has itself notches that mesh onto the teeth.

The synchronous transmissions of movement/power by notched belts include notably:
a bearing geometry with controlled deformation (range of elasticity of the material),
a curvilinear or polygonal profile toothing,
an ortho radial, straight, inclined or curvilinear toothing placed in the bearing plane.

The components of a movement/power transmission made with the inventive method are of a material having the mechanical characteristics sufficient to ensure the transmission function, for example of plastic, polymer, metal, composite, sandwich structure, etc.

The transmission elements of the method can include for example pulleys and belts that are smooth or that have teeth spaced according to a pitch less than two millimeters, for example micro-belts or wheels whose toothing height is on the order of 0.5 μm, as well as belts whose tooth depth or width is less than two millimeters. The thickness or the width of the belt itself is preferably also less than two millimeters. The limits of the machining precision are connected to the beam's offset. Such elements, notably such belts and such pulleys, are for example designed to be used in a watch movement, other components of a watch movement, or other micro mechanical parts.

By way of example, FIG. 2 illustrates a synchronous movement/power transmission 10 through a belt made entirely, or partly, with the inventive method. The assembly includes notably a main pulley 23, a belt 20, an auxiliary pulley 22 and a tensioning runner 21. The pulley 23 is flat and provided on its periphery with equidistant radial teeth that can be assimilated to a flat gearing wheel. The pulley 23 is provided with a flange (not represented) in order to guide the belt 20. It is possible to manufacture all the components of this transmission, or only part, with the inventive femtolaser-assisted ablation method.

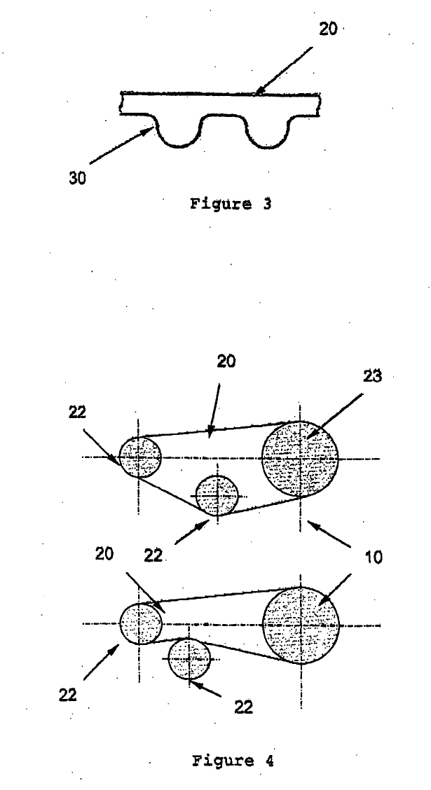

The belts 20 preferably have curvilinear toothing profiles 30 illustrated in FIG. 3. This curvilinear profile allows an efficient power transmission even when the belt's curvature radius varies considerably, for example when the belt works with pulleys of very different diameters. A curvilinear tooth profile can also be adopted for the pulleys.

When making a synchronous transmission, the flanges (not represented) are arranged on a single pulley 23, preferably on that which has the smallest diameter.

FIG. 4 illustrates two examples of asynchronous transmission 10 with internal/external auxiliary pulleys 22 and where the asynchronous pulley 23 is flat and provided with flanges (not represented) on both sides of said pulley 23 in order to guide the belt 20 on said transmission 10.

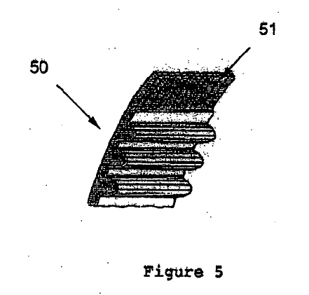

The present invention allows complex materials to be used without dimension limitations as well as structures of sandwich or composite type to be made, notably for the belts. FIG. 5 illustrates an example of stratified belts 50 with several layers 51.

It must be noted that in the case of pulleys 23 or of micrometric or nanometric elements of small dimensions with/without curvilinear profiles 30, no rule is imposed; the profiles are so-called personalized. Furthermore, for each type of toothing profile, there will be toothings with straight or winding flanks (not represented).

Manufacturing the Gearings

The invention also concerns the manufacture of millimetric or nanometric gearings, a gearing here being understood as the element coming into the composition of a synchronous transmission ensuring the connection between two arbors and transmitting a mechanical power from one driving arbor (motor) to a driven arbor (receptor) whilst maintaining a constant ratio of the angular speeds.

Different Forms of Gearings can be Considered:

The elementary form is so-called “external parallel” and is characterized, besides the absence of relative sliding of the two enmeshed wheels, by a ratio of angular speeds equal to the inverse ratio of the number of teeth or of the diameters and by a relative rotation of the wheels in the opposite direction. A variant is called “internal parallel”, where the two wheels turn in the same direction. This described form, parallel external or internal, with straight toothing, is also characterized by a pitch, a module and a ratio of transmission. The toothing's geometry is described in symmetrical fashion in the gearing plan following a curvilinear profile.

A more complex form answers the criteria of helical toothing defined by a “regulated Surface” caused by an infinity of tangents at the basis helix. It can also be defined as the surface caused by a winding moving along the helix.

The particular form called “rack-pinion” is characterized in that the rack is a particular wheel whose primitive line is straight, it can from the point of view of geometry be seen as a wheel with infinite diameter.

The transposition of the helical toothing to the rack pinion cinematic is possible. It is necessary to make sure that when the two primitive cylinders of the gearings turn without sliding, the two conjugated primitive helices remain constantly tangential, which implies two conditions:
the two helices must turn in opposite directions, i.e. one wheel on the left can form a parallel gearing only with a pinion on the right;
the geometric conditions linked to the gearing (meshing conditions) must be respected.

The inventive method also allows bevel gearings to be made. Initially, it is necessary to consider the straight shape in which the primitive surfaces are two cones having the same top that roll without sliding one on the other. The toothings are straight or spiraled. In the particular case of bevel gearings, it is necessary to pay care to the problems of gearing continuity and of interferences with the method called complementary gearing method. This approach allows the gearing to be studied in the bevel gearing, with a sufficient approximation, by simply considering a parallel gearing. Thus, all the questions relative to the gearing continuity, to the interferences, to the relative sliding, are treated by considering the parallel gearing following its angular speeds, the number of tooths, the pressure module and angle.

The present invention also allows warped gearings to be made, for example a wheel working with an endless worm. The endless worm meshes with its conjugated wheel with a given center-distance. In the prior art, the wheels are usually trimmed with a tool corresponding exactly to the endless worm with which it must mesh (envelope method). Use of an ultra-short pulse laser frees from this constraint to small dimensions that otherwise remained unfeasible through traditional methods. In this kind of gearing, particular care will be directed to the relative sliding as well as to the notion of reversibility.

The elaborated shape pertaining to helical warped gearings notably because of the punctual contact between teeth makes the operation with small loads particularly efficient for very small movements.

The complex shape called hypoid gearing will also be taken into account, especially in that the ablation method allows a very small dimension shape that is excluded by any other known method.

Independently of the shape and size of the gearings, it is essential, when designing, to observe the interference conditions and notably those linked to asymmetrical shapes and machining conditions.

The descriptive methods mentioned for generating curves and these warped surfaces ensures that the geometric interferences are mastered. Furthermore, the laser ablation technique by means of ultra-short pulses makes it possible to control the machining interferences. When conjugating these two aspects, the present invention provides an appropriate response to the definition, fabrication and mastering of interferences for micro and nano transmission, this independently of the toothing shapes and materials used.

Making the Micro Molds

In the prior art, the pulleys, toothed wheels and tensioning runners are made by traditional methods such as turning and/or milling, electro-erosion, ultrasound machining, etc. The traditional belts are made notably by molding, with the molds being made by electro-erosion, ultrasound or even by the LIGA process (Lithographie, Galvanisierung, Abformung—a process consisting of lithography, electroplating and molding).

These methods are suited for making micro molds having dimensions beyond the millimeter. They require the use of injectable plastic materials and are poorly suited for making parts using materials such as metals, composites or even heterogeneous multi-layers for example. Temperature or dynamic viscosity constraints limit the use of such micro molds, even for the manufacture of parts of synthetic materials.

Even if they can be put to use, the prior art techniques require molds to be made with sufficient precision. The present invention thus also has for object the micro molds used for making transmissions or transmission elements that are injected or that have sandwich-type or composite structures. For example, the stratified belt with several layers of FIG. 5 can advantageously be made, depending on the dimensions, by molding or injection in a micro mold machined with the inventive method.

Generally, the molds machined with the method described in the invention, whatever their type, call upon a certain number of functional sub-sets:
the molding elements: impression (stamp and matrix),
the functional elements: carcass, supply, mechanism for freeing and unmolding the injected parts, temperature regulation devices of the mold,
auxiliary elements: fastening and handling device, centering systems, robots for setup of inserts and extraction of molded parts, security and unmolding control devices.

The machining method with ultra-short pulse laser is adapted for making a cavity of the impression in which the three-dimensional negative representation of the object (all dimension corrections included) is limited by the two parts that are the stamp and the matrix.

This method allows any molded micro or nano part to be made as long as the molding art is maintained and that the viscosities of the materials used allow it (very small dimensions). The surface states achieved are excellent, which is important especially for friction parts.

Machinable Materials

Depending on the part to be machined, the inventive method can be used for machining a large number of different materials. It is particularly suited for machining isotropic, polymorphic (for example laminated . . . ) or hard composite materials, notably of plastic, metallic, mineral or composite matters.

Plastic material is understood to be any material having as main ingredient a “high polymer”, the definition being given in the norms ISO 472 and ISO 471 (January 2002). A “high polymer” or more generally a “polymer” is a product constituted of molecules characterized by a large number of repetitions of one or several species of atoms or groups of atoms (constitutional motives), linked in sufficient quantity to lead to a set of properties that practically do not vary with the adjunction or elimination of a single or of a small number of constitutional motives (ISO 472). It is also a product constituted of polymer molecules of high molecular mass (ISO 472).

The following plastic and/or polymer materials can notably be machined with the inventive method:
polyolefines, for example polyethylene PE, polypropylene PP, polyisobutylene P-IB, polymethylpentene P-MP,
polyvinyl chlorides PVC and their derivates according to ISO norms 1043-1/458-2/4575/1264 1060-2/2898-1, 6401 and especially chlorinated polyvinyl chloride PVCC, polyvinylidene chloride PVDC, copolymers of vinyl chloride and propylene VC/P, compounds of vinyl chloride and chlorinated polyethylene PVC/E, compounds of polyvinyl chlorides and acrylonitrile-butadiene-styrene PVC/ABS, graft copolymers of vinyl chloride and PVC/A, copolymers of vinyl chloride and vinyl acetate PVC/AC,
polyvinyl acetates PVAc and their derivates, notably polyvinyl acetate PVAC, polyvinyl alcohol PVAL, polyvinyl butylral (butyrate) PVB, polyvinyl formaldehyde PVFM,
styrenes (vinyl benzene) according to the norms ISO 1043-1/2580-1/2897-1/4894-1/6402-1, notably styrene butadiene SB, styrene acrylonitrile SAN, acrylonitrile-butadiene-styrene ABS, acrylate-styrene-acrylonitrile ASA, 3-(trimethoxysilyl)propyl methacrylate MSMA, compounds on the basis of polystyrene PS and notably PC/ABS, ABS/PA, PS/polyphenylene ether PPE, PS/PP and PS/PE, polyacrylics (polymethyl methacrylate) PMMA according to ISO 7823-1/7823-2/8257-1, polyacrylonitrile PAN, copolymer A/MMA acrylonitrile/methyl methacrylate, copolymer acrylonitrile/butadiene, copolymer styrene/acrylonitrile SAN, copolymer acrylonitrile/butadiene/styrene ABS, copolymer methyl methacrylate/acrylonitrile.butadiene/styrene MBS, etc.
compounds or alloys PMMA/AES,
saturated polyesters—polyalkylene polybutylene terephthalate PET and PBT according to ISO 1043-1/1628-5/7792-1,
polyamides PA according to ISO 1043-1/1874-1/599/3451-4/7628-1/7628-2/7375-1/7375-2, notably nylon PA 6.6, PA 6.10, PA 6.12, PA 4.6, PA 6, PA 11, PA 12 etc.
polyoxymethylene POM according to ISO 1043-1, fluoro-polymers according to ISO 10943-1, polytetrafluoroethylene PTFE, polychlorotrifluoroethylene PCTFE, polyvinylidene fluoride PVDF, fluorinated ethylene-propylene FEP, the ethylene copolymer PTFE ETFE, cellulosics according to ISO 1043-1, cellulose nitrate or nitrocellulose CN, ethyl cellulose EC and methyl cellulose MC, cellulose acetate CA and cellulose tri-acetate CTA,
aromatic skeleton polymers according to ISO 1043-1, notably polycarbonates PC according to ISO 1043-1/1628-4/7391-1/7391-2, polyphenylene sulphide PPS, polyphenylene ether PPE, poly(2,6-dimethyl-1,4-phenylene oxide, polyphenylene ether, polyetheretherketone PEEK, polyaryletherketone PAEK, polyetherketone, aromatic polysulphone PSU, polyether sulphone PESU, polyphenylsulphone PPSU, aromatic polyamide, polaryl amide PAA, polyphthalamide PPA, semi-aromatic amorphous polyamids PA 6-3T, polyamide imide PAI, bisphenol A polyterephthalate (polyacrylates), polyetherimide PEI, cellulose propionate CP and cellulose acetate propionate CAP, cellulose acetate-butyrate CAB, liquid crystal polymers (Vectra®, Sumika® and Zenite®, thermoplastic elastomers according to ISO 1043-1, sequenced copolymers of the type Hytrel© or Pebax©, ionomers of the type Surlyn©, the ultrablend S© (BASF) PBT+ASA, the Cycloloy© (GB Plastics, Lastilac (Lati) PC+ABS, Xenoy© (GE plastics) PC+PET, Orgalloy© RS6000 (ATO) PA6/PP, STAPRON© N (DSM) ABS/PA 6, Lastiflex© AR-V0 (Lati), PVC+terpolymers, etc.
polyurethanes according to ISO 1043-1 notably for obtaining cast elastomers or thermoplastics or polyurethane-polyurea (thermohardening) or cellular polyurethanes, micro-cellular elastomers from the following composites: polyurethane PUR, isocyanate+hydrogen provider, isocyanate, polyisocyanates and notably toluene diisocyanate toluene TDI, polyols (polyesters and polyethers), amines MDA and MOCA, silicones SI according to ISO 1043-1, silicone polysiloxane SI, phenoplasts PF (phenol-formaldehyde) and notably PF2E1, PF2C1. PF2C3, PF2A1-2A2, PF1A-1A2, PF2DA, PF2D4, aminoplasts (melamine formaldehyde MF, urea formaldehyde UF) according to ISO 4614 and 1043-1, melamine formaldehyde MF, urea formaldehyde UF, thermohardening insaturated polyesters.

Generally, it will be noted that whenever possible and desired, these materials can be reinforced, in particular with the following materials: aromatic polyamide (Kevlar© of Dupont de Nemours), glass in all its forms including sodic silicon forms, high module carbon, high resistance carbon, borons, steels, mica, wollastonite, calcium carbonate, talc, polytetrafluoroethylene PTFE, for example Teflon© etc.

Furthermore, machined plastic products can or not be covered with mineral, synthetic or metallic films.

The inventive method also applies to the machining of most pure metals and their alloys. One can mention notably solid metallic alloys, steels and castings of aluminum, of nickel or chromium, of molybdenum, of tungsten (wolfram) or manganese, of gold, of platinum or silver, of titanium or cobalt, of boron or niobium, of tantalum, as well as pure metals.

Many minerals, including quartz, can also be machined using this method. Finally, it is also adapted for machining composite materials, i.e. materials with a matrix/organic or metallic bonding agents, and including notably, without being exhaustive, phenols, polyesters, epoxy, poly-imides, reinforced fibers/additive reinforcements (mainly celluloses, glass E, C, S, R, boron), trichites (whiskers) AlO3, SiO2, ZrO2, MgO, TiO2, BeO, SiC, low module aramide, high module aramide, high tenacity carbon, high module carbon, boron, steel, aluminum, etc. as well as materials loaded with mineral materials, in particular chalk, silica, kaolin, titanium oxide, solid glass balls, etc.

These composites can comprise additives, notably catalysts or accelerators and, in solid state, can be in the form monolayer, stratified, sandwich, etc.

The following composites will be cited more particularly, though not exhaustively: aluminum/copper-metallic matrix composite Al 77.9/SiC 17.8/Cu 3.3/Mg 1.2/Mn 0.4; aluminum/lithium composite-metallic matrix Al 81/SiC 15/Li 2/Cu 1.2/Mg 0.8; carbon/vinyl ester-carbon fiber-vinyl ester matrix; carbon/polyaramide-carbon fiber-polyaramide fiber; carbon/carbon composite-carbon fiber-carbon matrix; carbon/epoxy composite-carbon fiber-epoxy matrix; carbon/polyetheretherketon composite-carbon fiber-PEEK matrix; polyaramide/vinyl ester composite-polyaramide fiber-vinyl ester matrix; polyethylene/polyethylene composite-polyethylene fiber-polyethylene matrix; E-glass/epoxy-borosilicate glass/epoxy; polyaramide/polyphenylene sulphide-polyaramide fiber-PPS matrix.

Finally, many ceramics can be machined with the inventive method. Ceramics are constituted of raw materials that can be natural polycrystalline or polyphased or even synthetic of the type fritted alumina, silica, alumino-silicate or magnesio-silicate composites (cordierite, mullite, steatite) and more widely oxynitrides, sialon, carbides . . . . The preferred materials are short monocrystalline fibers dispersed inside an organic, metallic or ceramic matrix. As well as metallic carbide whiskers, as well as organo-metallic precursors such as SiC or Si3N4 . . . . These materials can be used by dry pressing, thermoplastic molding, tape casting, etc.

We indicate as main ceramics, without this being exhaustive, alumina Al2O3, alumina/silica Al2O3 80/SiO2 20, alumina/silica Al2O3, 96/SiO2 4—Saffil®, alumina/silica/boron oxide Al2O3 70/SiO3 38/B2O 2, alumina/silica boron oxide Al2O3 62/SiO2 24/B2O 14, potassium aluminosilicate Muscovite Mica, boron carbide B4C, silicon carbide SiC, reaction-bound silicon carbide SiC, hot-pressed silicon carbide SiC, tungsten/cobalt carbide WC 94/Co6, machinable glass ceramic SiO2 46/Al2O3 16/MgO 17/K2O 10/B2O3 7, permeable ceramic SiO2 50/ZrSiC 40/Al2O3 10, titanium diboride TiB2, titanium dioxide TiO2 99.6%, magnesium oxide MgO, aluminum nitride AlN, machinable Shapal-M® aluminum nitride, boron nitride BN, silicon nitride Si3N4, reaction-bound silicon nitride Si3N4, hot pressed silicon nitride Si3N4, silicon nitride/aluminum nitride/alumina, sialon, zinc oxide/alumina ZnO 98/Al2O3 2, yttrium oxide Y2O3, beryllium oxide BeO 99.5, melted quartz SiO2, ruby Al2O3/Cr2O3/Si2O3, sapphire Al2O3 99.9, alumina silicate SiO2 53/Al2O3 47, silica SiO2 96, alumino-silicate glass—alumina-silicate SiO3 57/Al2O3 36/CaO/MgO/BaO, non-stabilized zirconium ZrO2 99, yttria-stabilized zirconium ZrO2/Y2O3, magnesia-stabilized zirconium ZrO2/MgO, etc.

Thanks to the very localized matter heating, use of an ultra-short pulse laser allows:
in plastic materials, a cutting without thermal damage to the cutting zone,
in composite materials, a direct cutting without delaminating the multi-layer material,
the machining of all metals without runs or flushes or even flaring of the level of the incident surface.

### LIST OF REFERENCES

10 Machined part, for example transmission such as a belt.
11 Work surface
12 Holding means (fastening means)
13 Information processor for executing a three-dimensional modeling program
14 Femtolaser
15 Optical head
16 Laser beam
17 Information processor for executing the machining program
X, Y, Z Translation axes of the part to be machined
A, B, C Rotation axes of the part to be machined
20 Belt
21 Belt tensioning idler pulley
22 Auxiliary pulley
23 Main pulley
30 Curved toothing
50 Stratified belt
51 Reinforcement

1. A method for producing micro mechanical or nano mechanical parts, comprising a step of laser-assisted ablation by means of a laser with pulses of a duration less than 5×10⁻¹³ seconds and with a power greater than 10¹² watts on the beam-matter interaction surface.

2. The method of claim 1, used for making parts intended for watchmaking.

3. The method of claim 2, used for making pulleys and/or belts.

4. The method of claim 1, wherein at least one dimension of the part is lower than or equal to two millimeters, or preferably less than 0.5 millimeters, this dimension being counted overall and defined as the length of the segment that connects the two most distant points of an element part along the same direction.

5. The method of claim 3, wherein said part comprises teeth whose depth is less than two millimeters.

6. The method of claim 1, comprising a step of holding said part by a micro-manipulator ensuring the positioning and orientation of the surface to process relatively to the orientation of the laser beam.

7. The method of claim 1, having the following steps:
describing the shapes to be machined,
transferring the data corresponding to said description onto a machining software, said machining software preferably taking into account notably interpolations of warped surfaces,
defining the beam's angle of incidence and the position of the part to machine relatively to the laser beam, according to the material and the machining depth, so that the ablation conditions can be optimized,
entering the data in the movement control and/or steering information processor,
adjusting the ultra-short pulse laser having a duration less than 5×10⁻¹³ seconds and with a power greater than 10¹² watts on the beam-matter interaction surface,
starting the machining program and machining the part by pulse laser.

8. The method of claim 1, wherein the energy gradient of the laser beam is determined so that only the intensity of a central zone whose section is less than 50% of the beam's total section is greater than the material's ablation threshold.

9. The method of claim 1, wherein the ablation is performed only in the focal plane of the laser beam, the method including a step of moving said focal plane relatively to said part in a direction perpendicular to said laser beam.

10. The method of claim 1, wherein said part to machine is held by a multi-axial system controlled by a machining program, for example a micrometric or even nanometric robot machining program with play compensation or retrofit.

11. The method of claim 1, wherein the power and the duration of the pulses are chosen depending on the part's material so as to allow the ablation of some μm of matter, preferably less than 10 μm, per pulse.

12. The method of claim 1, wherein the ablation is performed in vacuum, under projection of neutral gas or in controlled atmosphere in order to avoid the appearance of non-linear phenomena generated within the light-material interface such as air breakdown or material alteration.

13. The method of claim 1, using a diffraction device of the laser beam.

14. The method of claim 1, requiring a step of positioning said part in a plane.

15. The method of claim 2, said element part having at least one of the following components:
plastic material,
metal,
composite,
ceramic,
mineral material,
complex organic matrix material,
hard isotropic material.

16. The method of claim 7, wherein said description of the shapes to be machined is performed from the geometry defined on a plan of a 3D CAD system,
the machining pitch being defined according to the material and the machining depth, so that the ablation conditions can be optimized,
the focal zone being positioned through lighting by means of an optical head, equipped or not with a diffraction device.

17. A method for producing micro mechanical or nano mechanical pulleys and/or belts intended for watchmaking, comprising a step of laser-assisted ablation.

18. A method for producing micro mechanical or nano mechanical parts by laser-assisted ablation by means of a laser with pulses of a duration less than 5×10⁻¹³ seconds and with a power greater than 10¹² watts on the beam-matter interaction surface,
wherein the energy gradient of the laser beam is determined so that only the intensity of a central zone whose section is less than 50% of the beam's total section is greater than the material's ablation threshold.

19. Element made according to the method of claim 1.

20. The element of claim 19, wherein at least one of its dimensions is less than or equal to two millimeters, or preferably less than 0.5 millimeter, this dimension being counted overall and defined as the length of the segment that connects the two most distant points of an element part along the same direction.

21. The element of claim 20, comprising teeth spaced according to a pitch less than two millimeters and/or whose depth is less than two millimeters.

22. The element of claim 20, having at least one curvilinear line, for example an irregular curvilinear line, formed in a plane perpendicular to the element, of at least one radius greater than 10⁻⁹ m and less than 5 mm.

23. The element of claim 22, intended for an horological application.

24. The element of claim 23, constituted by a synchronous or asynchronous transmission.

25. The element of claim 24, constituted by a belt and/or by a pulley.

26. The element of claim 25, wherein said belt has a thickness or a width less than two millimeters.

27. The element of claim 23, constituted by one of the following elements:
an element of y watch escapement system;
an element of a watch regulating system; or
an element of the chain for the cinematic transmission of the energy and of the movements between the power source and the hands of a watch.

28. The element of claim 25, whose largest dimension is less than one millimeter.

29. The element of claim 19, being intended for an application outside watchmaking.

30. The element of claim 19, constituted by at least one of the following elements:
at least one gearing;
at least one tensioning and/or toothed runner;
a mold, for example a circular-shaped mold;
a flange, for example a toothed flange.

31. The element of claim 19, made of a hard isotropic material.

32. A belt for a watch movement,
with a pitch between teeth of less than two millimeters
with a teeth depth of less than two millimeters,
with a thickness or a width less than two millimeters,
made with a laser ablation process using a laser with pulses of a duration less than 5×10⁻¹³ seconds and with a power greater than 10¹² watts on the beam-matter interaction surface.

33. Device for making transmission elements, notably belts, by using the method of claim 1, including:
a laser with pulses of a duration less than 5×10⁻¹³ seconds and with a power greater than 10¹² watts on the beam-matter interaction surface,
holding means for holding a part to be machined,
an information processor for executing a machining program including a step of moving the focal zone of said pulse laser relatively to said part along several axes.

34. The device of claim 33, further including an information processor for generating said machining program from a three-dimensional representation of the part to be machined.
